(19) United States
(12) Patent Application Publication
(10) Pub. No.: US 2015/0270702 A1
(43) Pub. Date: Sep. 24, 2015

(54) POWER SUPPLY DEVICE WITH OVER-VOLTAGE PROTECTION

(71) Applicant: Chicony Power Technology Co., Ltd., New Taipei City (TW)

(72) Inventors: Lieh-Chung YIN, New Taipei City (TW); Chia-Hsien YEN, New Taipei City (TW); Tzu-Hung WANG, New Taipei City (TW)

(21) Appl. No.: 14/447,462

(22) Filed: Jul. 30, 2014

(30) Foreign Application Priority Data
Mar. 19, 2014 (TW) 103110243

(51) Int. Cl. H02H 7/12; H02M 3/335

(52) U.S. Cl. CPC H02H 7/1213; H02M 3/335

(57) ABSTRACT

A power supplying device includes a power supplying unit, a first switching element, a compensating unit, a controller, and an over-voltage protecting unit. The power supplying unit includes a main power-outputting terminal, a standby power-outputting terminal, a DC to DC power converter, and a first sensing resistor. The DC to DC power convertor includes a power-outputting terminal The first sensing resistor is electrically connected to the power-outputting terminal and the main power-outputting terminal The first switching element is electrically connected to the first sensing resistor and the main power-outputting terminal The compensating unit is electrically connected to the main power-outputting terminal The controller is electrically connected to the compensating unit and the power supplying unit. The over-voltage protecting unit is electrically connected to the main power-outputting terminal, the first switching element, the standby power-outputting terminal, the power-outputting terminal, and the compensating unit.

### BACKGROUND OF THE INVENTION

1. Field of the Invention

The present invention relates to power supplying device, and in particular to a power supplying device with over-voltage protection.

2. Description of Related Art

Reference is made to FIG. 1, which is a circuit block diagram of a related art power supplying device with over-voltage protection. The power supplying device with over-voltage protection 1 includes a power converting unit 10, a controller 12, a compensating unit 14, a first switching element 16, an over-voltage protecting unit 18, and a second switching unit 20.

The power converting unit 10 includes a main power-outputting terminal VA and a standby power-outputting terminal VB. The main power-outputting terminal VA and the standby power-outputting terminal VB respectively output electric power to an electronic system (not shown). In particularly, the standby power-outputting terminal VB outputs an electric power to the electronic system when the electronic system is operated both in a standby mode and a non-standby mode, and the main power-outputting terminal VA outputs an electric power to the electronic system only when the electronic system is operated in the non-standby mode. In short, the power supplying unit 10 determines to conduct the electric power outputted from the standby power-outputting terminal VB only to the electronic system (or to conduct electric power outputted both from the main power-outputting terminal VA and the standby power-outputting terminal VB to the electronic system) according to the operation mode of the electronic system, so as to achieve power-saving.

The power converting unit 10 includes a direct current (DC) to DC power converter 100, a regulator 102, a first sensing resistor Rs1, and a second sensing resistor Rs2. The DC to DC power converter 100 includes a power-outputting terminal Vo. The first sensing resistor Rs1 is arranged between the power-outputting terminal Vo and the main power-outputting terminal VA and electrically connected to the power-outputting terminal Vo and the main power-outputting terminal VA. The regulator 102 is electrically connected to the power-outputting terminal Vo. The second sensing resistor Rs2 is arranged between the regulator 102 and the standby power-outputting terminal VB, and electrically connected to the regulator 102 and the standby power-outputting terminal VB.

The controller 12 is electrically connected to the DC to DC power converter 100 of the power converting unit 10. The controller is configured to control power converting states of the DC to DC power converter 100, and then adjust voltage level of the electric power outputted from the DC to DC power convertor 100.

The compensating unit 14 is electrically connected to the main power-outputting terminal VA and the controller 12. The compensating unit 14 includes a resistor network 140 and an isolator 142. The resistor network 140 is electrically connected to the main power-outputting terminal VA. The isolator 142 includes a signal-emitting terminal 1420 and a signal-receiving terminal 1422. The signal-emitting terminal 1420 is electrically connected to the resistor network 140, and the signal-receiving terminal 1422 is electrically connected to the controller 12. The controller 12 controls power converting states of the DC to DC power converter 100 according to signals sent from the signal-receiving terminal 1422 of the isolator 142.

The first switching element 16 is arranged between the main power-outputting terminal VA and the first sensing resistor Rs1, and electrically connected to the main power-outputting terminal VA and the first sensing resistor Rs1 in series.

The over-voltage protecting unit 18 includes a first comparator 180 and a second comparator 182. The first comparator 180 includes two inputting terminals and an outputting terminal, one of the inputting terminals is electrically connected to the main power outputting terminal VA, the other is used for inputting a first reference voltage Vref1, and the outputting terminal thereof is electrically connected to the first switching element 16. The first comparator 180 turns the first switching element 16 on or off for deciding to conduct the electric power to the electronic system via the main power-outputting terminal VA or not by comparing a voltage of the electric power outputting from the main power-outputting terminal VA and the first reference voltage Vref1. The second comparator 182 includes two inputting terminals and an outputting terminal, one of the inputting terminals is electrically connected to the standby power-outputting terminal VB, and the other is used for inputting a second reference voltage Vref2. The second comparator 182 compares a voltage outputted from the standby power-outputting terminal VB and the second reference voltage Vref2, and then adjusts the voltage level of electric power outputted from the standby power-outputting terminal VB.

The second switch element 20 is arranged between the main power-outputting terminal VA and the compensating unit 142, and electrically connected to the main power-outputting terminal VA and the compensating unit 14.

When the power supplying device 1 is in a test of over-voltage protection, the second switch element 20 opens, so that the compensating unit 14 cannot feedback the electric power outputted from the main power-outputting terminal VA to the controller 12. After that, the voltage level of the electric power outputted from the main power-outputting terminal VA is continually increased, and in the same time, the voltage level of the electric power outputted from the standby power-outputting terminal VB is also continually increased.

While a voltage level of the electric power outputted from the main power-outputting terminal VA is higher than that of the first reference voltage Vref1, the outputting terminal of the first comparator 180 sends a signal to turn the first switching element 16 off and stops the main power-outputting terminal VA conducting electric power to the electronic system. Besides, while the voltage level of the power-outputting terminal Vo is higher than a predetermined voltage level, the DC to DC power converter 100 stops power converting, which means the power supplying device 1 stop providing electric power to the electric power, and then the electronic system stop operating.

### SUMMARY OF THE INVENTION

The object of the present invention is to provide power supplying device with over-voltage protection.

Accordingly, the present provides a power supplying device with over-voltage protection. The power supplying device is electrically connected to an electronic system and includes a power supplying unit, a first switching element, a compensating unit, a controller, and an over-voltage protecting unit. The power supplying unit includes a main power-outputting terminal and a standby power-outputting terminal, and the main power-outputting terminal and the standby power-outputting terminal are electrically connected to the electronic system. The power supplying unit also includes a direct current (DC) to DC power converter, a first sensing resistor, and a second sensing resistor. The DC to DC power converter has a power-outputting terminal The first resistor is electrically connected to the power-outputting terminal and the main power-outputting terminal The second sensing resistor is electrically connected to the power-outputting terminal and the standby power-outputting terminal. The first switching element is electrically connected to the first sensing resistor and the main power-outputting terminal, the compensating unit is electrically connected to the main power-outputting terminal, and the controller is electrically connected to the compensating unit and the power supplying unit.

The over-voltage protecting unit includes a first comparator, a second comparator, and a third comparator. The first comparator includes two inputting terminals and an outputting terminal, one of the inputting terminals is electrically connected to the main power-outputting terminal, and the outputting terminal is electrically connected to the first switching element. The second comparator includes two inputting terminals and an outputting terminal, and one of the inputting terminals is electrically connected to the standby power-outputting terminal The third comparator includes two inputting terminals and an outputting terminal, one of the inputting terminals is electrically connected to the power-outputting terminal, and the outputting terminal is electrically connected to the compensating unit.

In an embodiment of the present invention, the power supplying unit further includes a regulator electrically connected to the power-outputting terminal and the second sensing resistor.

In an embodiment of the present invention, the compensating unit includes a resistor network and an isolating element. The resistor network is electrically connected to the main power-outputting terminal, and the isolating element is electrically connected to the resistor network and the controller.

In an embodiment of the present invention, the isolating element includes a signal-emitting terminal and a signal-receiving terminal, the signal-emitting terminal is electrically connected to the resistor network, and the signal-receiving terminal is electrically connected to the controller.

In an embodiment of the present invention, the outputting terminal of the third comparator is electrically connected to the resistor network and the signal-emitting terminal of the isolating element.

In an embodiment of the present invention, the isolating element is an photo coupler.

In an embodiment of the present invention, wherein the DC to DC power converter is an LLC power converter.

In an embodiment of the present invention, the other inputting terminal of the first comparator is used for inputting a reference voltage, the other inputting terminal of the second comparator is used for inputting a second reference voltage, and the other inputting terminal of the third comparator is used for inputting a third reference voltage.

In an embodiment of the present invention, the power supplying device further includes a second switching element electrically connected to the power-outputting terminal and the compensating unit.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit block diagram of a related art power supplying device.

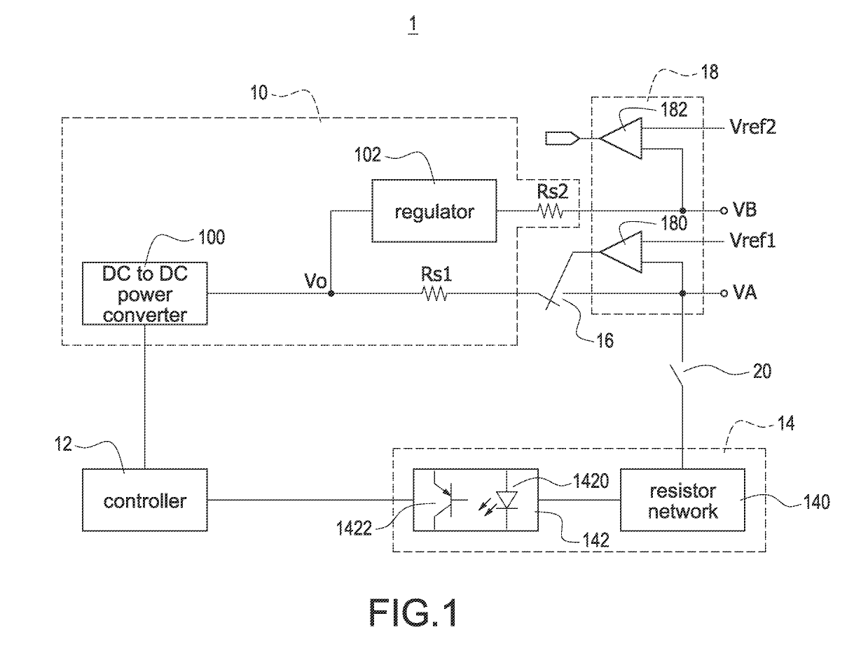

FIG. 2 is a circuit block diagram of a power supplying device with over-voltage protection according to the present invention.

### DETAILED DESCRIPTION OF THE INVENTION

A preferred embodiment of the present invention will be described with reference to the drawings.

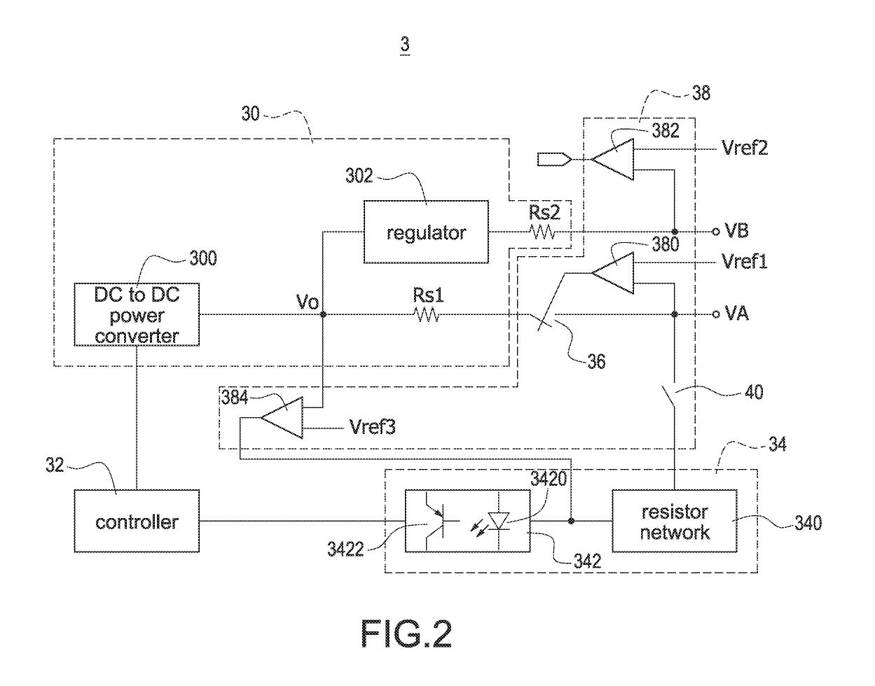

Reference is made to FIG. 2, which is a circuit block diagram of a power supplying device with over-voltage protection according to the present invention. The power supplying device 3 includes a power converting unit 30, a controller 32, a compensating unit 34, a first switching element 36, an over-voltage protecting unit 28, and a second switching element 40.

The power converting unit 20 includes a main power-outputting terminal VA and a standby power-outputting terminal VB. The main power-outputting terminal VA and the standby power-outputting terminal VB are electrically connected to an electronic system (not shown) and output voltage to the electronic system, respectively. In particularly, the standby power-outputting terminal VB outputs an electric power to the electronic system when the electronic system is operated both in a standby mode and a non-standby mode, and the main power-outputting terminal VA outputs an electric power to the electronic system only when the electronic system is operated in the non-standby mode. In short, the power supplying unit 30 determines to conduct the electric power outputted form the standby power-outputting terminal VB only to the electronic system (or to conduct electric power outputted both from the main power-outputting terminal VA and the standby power-outputting terminal VB to the electronic system) according to the operation mode of the electronic system, so as to achieve power-saving.

The power converting unit 30 includes a direct current (DC) to DC power converter 300, a regulator 302, a first sensing resistor Rs1, and a second sensing resistor Rs2. The DC to DC power converter 300 has a power-outputting terminal Vo. The first sensing resistor Rs1 is arranged between the power-outputting terminal Vo and the main power-outputting terminal VA, and electrically connected to the power-outputting terminal Vo and the main power-outputting terminal VA. The regulator 302 is electrically connected to the power-outputting terminal The second sensing resistor Rs2 is arranged between the regulator 302 and the standby power-outputting terminal VB, and electrically connected to the regulator 302 and the standby power-outputting terminal VB. In this embodiment, the DC to DC power converter 300 is, for example, an LLC power convertor.

The first switching element 36 is arranged between first sensing resistor Rs1 and the main power-outputting terminal VA, and electrically connected to the first sensing resistor Rs1 and the main power-outputting terminal VS. The first switching element 36 determines to conduct the electric power outputted from the power-outputting terminal Vo to the electronic system or not via the main power-outputting terminal VA.

The controller 32 is electrically connected to the DC to DC converter 300 of the power converting unit 30. The controller is configured to control power converting states of the DC to DC power converter 300 and then adjust a voltage level of the electric power outputted from the DC to DC power converter 300. In this embodiment, the controller 32 adjusts the voltage level of the electric power outputted from the DC to DC power convertor 300 by controlling operating frequencies thereof.

The compensating unit 34 is electrically connected to the main power-outputting terminal VA and the controller 32. The compensating unit 34 includes a resistor network 340 and the isolator 342. The resistor network 340 is electrically connected to the main power-outputting terminal VA. The isolator 342 includes a signal-emitting terminal 3420 and a signal-receiving terminal 3422, the signal-emitting terminal 3420 is electrically connected to the resistor network 340, and the signal-receiving terminal 3422 is electrically connected to the controller 32. The controller 32 adjusts the power converting states of the DC to DC power convertor 300 according to signals sent from the signal receiving terminal 3422 of the isolator 342 electrically connected thereto. In this embodiment, the isolator 342 is, for example, photo coupler.

The over-voltage protecting unit 38 includes a first comparator 380, a second comparator 382, and a comparator 384. The first comparator 380 has two inputting terminals and an outputting terminal, one of the inputting terminals is electrically connected to the main power-outputting terminal VA, the other is used for inputting a first reference voltage Vref1, and the outputting terminal is electrically connected to the first switching element 36. The first comparator 380 is configured to control operation states of the first switch element 36 (namely the first comparator 380 is used for turning the first switching element on or off) for determining to conduct the electric power to the electronic system via the main power-outputting terminal VA or not by comparing a voltage of the electric power outputted form the main power-outputting terminal VA and the first reference voltage Vref1.

The second comparator 382 includes two inputting terminals and an outputting terminal One of the inputting terminals is electrically connected to the standby power-outputting terminal, and the other is used for inputting a second reference voltage Vref2. The second comparator 382 compares a voltage outputted from the standby power-outputting terminal VB and the second reference voltage Vref2, and then adjusts the voltage level of electric power outputted from the standby power-outputting terminal VB.

The third comparator 384 includes two inputting terminal and an outputting terminal One of the inputting terminal is electrically connected to the power-outputting terminal Vo, the other is used for inputting a third reference voltage Vref3, and the outputting terminal is electrically connected to the resistor network 340 and the signal-emitting terminal 3420 of the isolator 342.

The second switching element 40 is arranged between the main power-outputting terminal VA and the compensating unit 34 and electrically connected to the main power-outputting terminal VA and the compensating unit 34.

When the power supplying device 3 is in a test od over-voltage protection, the second switching element 40 opens, and the voltage level of the electric power outputted from the power-outputting terminal Vo is increased, therefore the electric power outputted from the main power-outputting terminal VA and the standby power-outputting terminal VB are also increased.

If the electric power outputting from the power-outputting terminal Vo is larger than a third reference voltage Vref3, the third comparator 384 sends a signal to drive the signal-emitting terminal 3420 of the isolating element 342 illuminate. After that, the signal-receiving terminal 3422 receives the light emitted form the signal-emitting terminal and then drives the controller 32 to control the DC to DC power converter 300, so as to prevent the voltage level of the electric power continually increases and achieves over-voltage protection.

Although the present invention has been described with reference to the foregoing preferred embodiment, it will be understood that the invention is not limited to the details thereof Various equivalent variations and modifications can still occur to those skilled in this art in view of the teachings of the present invention. Thus, all such variations and equivalent modifications are also embraced within the scope of the invention as defined in the appended claims.

1. A power supplying device with over-voltage protection electrically connected to an electronic system, the power supplying device with over-voltage protection comprising:
a power supplying unit comprising:
a main power-outputting terminal electrically connected to the electronic system;
a standby power-outputting terminal electrically connected to the electronic system;
a direct current (DC) to DC power converter comprising a power-outputting terminal;
a first sensing resistor electrically connected to the power-outputting terminal and the main power-outputting terminal; and
a second sensing resistor electrically connected to the power-outputting terminal and the standby power-outputting terminal;
a first switching element electrically connected to the first sensing resistor and the main power-outputting terminal;
a compensating unit electrically connected to the main power-outputting terminal;
a controller electrically connected to the compensating unit and the power supplying unit; and
an over-voltage protecting unit comprising:
a first comparator comprising two inputting terminals and an outputting terminal, one of the inputting terminals electrically connected to the main power-outputting terminal, and the outputting terminal electrically connected to the first switching element;
a second comparator comprising two inputting terminals and an outputting terminal, one of the inputting terminals electrically connected to the standby power-outputting terminal; and
a third comparator comprising two inputting terminals and an outputting terminal, one of the inputting terminals electrically connected to the power-outputting terminal, and the outputting terminal electrically connected to the compensating unit.

2. The power supplying device with over-voltage protection in claim 1, wherein the power supplying unit further comprises a regulator arranged between the power-outputting terminal and the second sensing resistor, and electrically connected to the power outputting terminal and the second sensing resistor.

3. The power supplying device with over-voltage protection in claim 2, wherein the compensating unit comprises a resistor network and an isolating element, the resistor network is electrically connected to the main power-outputting terminal, and the isolating element is electrically connected to the resistor network and the controller.

4. The power supplying device with over-voltage protection in claim 3, wherein the isolator comprises a signal-emitting terminal and a signal-receiving terminal, the signal-emitting terminal is electrically connected to the resistor network, and the signal-receiving terminal is electrically connected to the controller.

5. The power supplying device with over-voltage protection in claim 4, wherein the outputting terminal of the third comparator is electrically connected to the resistor network and the signal-emitting terminal of the isolator.

6. The power supplying device with over-voltage protection in claim 5, wherein the isolator is photo coupler.

7. The power supplying device with over-voltage protection in claim 6, wherein the DC to DC power converter is an LLC power convertor.

8. The power supplying device with over-voltage protection in claim 7, wherein the other outputting terminal of the first comparator is used for inputting a first reference voltage, the other outputting terminal of the second comparator is used for inputting a second reference voltage, and the other inputting terminal of the third comparator is used for inputting a third reference voltage.

9. The power supplying device with over-voltage protection in claim 8, further comprising a second switching element electrically connected to the main power-outputting terminal and the compensating unit.
